(19) United States
(12) Patent Application Publication
(10) Pub. No.: US 2004/0151817 A1
(43) Pub. Date: Aug. 5, 2004

(54) Baked products containing soybean protein and process for producing soybean protein

(76) Inventors: Yoichi Fukuda, Tsukuba-gun (JP); Yasue Nagao, Tsukuba-gun (JP); Yasuko Matuzaki, Tsukuba-gun (JP); Shinichi Imai, Tsukuba-gun (JP); Hiroyuki Gunji, Hokkaido (JP)

Correspondence Address: SUGHRUE MION, PLLC, 2100 PENNSYLVANIA AVENUE, N.W., SUITE 800, WASHINGTON, DC, 20037, US

(21) Appl. No.: 10/479,713

(22) PCT Filed: May 16, 2002
(86) PCT No.: PCT/JP02/04762

(30) Foreign Application Priority Data
Jun. 7, 2001 (JP) 2001-172258
Sep. 7, 2001 (JP) 2001-271901

(51) Int. Cl. A21D 10/00

(52) U.S. Cl. 426/549

(57) ABSTRACT

The invention provides a process for producing a baked food of wheat flour by using a soybean protein in which NSI shows a low denature value of 40 or more, the content of solid component extracted with a solvent mixture of chloroform and methanol (2:1) is 2.0 wt % or less, and the crude protein content is 63% or more. When wheat flour in dough is replaced with the soybean protein at a small ratio, baked foods of wheat flour which are resistant to freezing and show good texture even after thawing in a microwave oven can be obtained. Moreover, a process for making a baked food mainly comprising soybean proteins, which has a good taste and texture and is appropriately taken by human, can be provided by replacing most part or all of wheat flour with a soybean protein. In addition, the invention provides a process for producing a low denatured soybean protein having a good color and taste which comprises treating low denatured defatted soybeans as proteinous materials used in baked foods with an alcohol while regulating a decrease in NSI.

### TECHNICAL FIELD

The present invention relates to a process for producing baked foods resistant to a freezing operation or baked foods containing a large quantity of soybean proteins in the form suitable for intake of nutritiously effective soybean proteins in human which comprises replacing wheat flour with a particular soybean protein at a dough stage in the foods of baked type of wheat flour, as well as a process for producing the soybean proteins.

### BACKGROUND ART

Soybean proteins have long been utilized widely not only as an excellent food protein source but also as food materials or food reforming materials in meat products, fish paste products, side dishes, bread, confectionaries, drink materials, and so on, since they have a variety of functional properties such as emulsifying power, gel-forming power, water retention power, and so on. Recently, it has been found that soybean proteins can reduce blood cholesterol, and therefore their nutritional physiological function has attracted a great deal of attention.

Usual soybean proteins, however, have a characteristic flavor and a color tone, which sometimes limit the utilization of them. As a commercial process for improving such a smell, taste or color of soybean proteins, there is a known process for producing enriched soybean proteins which comprises treating defatted soybeans with an aqueous alcohol. In the commonly available products treated with an aqueous alcohol, however, the proteins contained therein have been denatured during treatment with an alcohol and drying to greatly decrease their solubility in water (nitrogen solubility index; NSI), resulting in limitation of diverse use as foods (J. Agric. Chem., vol. 27, no.5, 989, 1979; J.A.O.C.S., vol.39, 222, 1962). There is a strong demand for soybean proteins having a good taste and color tone with lower decrease of NSI, and an attempt has been made for obtaining such soybean proteins. According to JP-A-8-9891 (the term “JP-A” as used herein means an “unexamined published Japanese patent application”), the denatured soybean proteins are treated with a protease in a weak alkaline condition to recover NSI. In this method, however, the enzymatic degradation of proteins produces low molecular products of which the physical properties and the utility are far different from those of the original soybean proteins.

The present inventors have proposed in JP-A-2000-325023 a process for producing soybean proteins by extraction with a solvent mixture of chloroform and methanol (2:1), in which the resulting proteins are superb in color and taste with a lower lipid content and lower decrease of NSI.

In this connection, frozen foods have widely been spread in our dietary habits because of their convenience, and even baked wheat flour products such as pancakes (hot cakes) or Japanese Takoyaki (grilled dumplings with bits of octopus) have appeared on the market as frozen products. In these baked wheat meal products, however, there is a problem that when they are thawed after kept in a freezer, particularly thawed in a microwave oven, they become stiff and sticky (strong influence) and their taste is decreased in comparison with those immediately after baking. In order to suppress such a change of texture, it has long been known to add a chemically synthesized emulsifying agent such as glycerin fatty acid ester, sucrose fatty acid ester or propylene glycol fatty acid ester to a frozen commercial product of baked wheat flour food. In utilization of natural products, it has been attempted to add an additive ingredient such as lecithin, enzyme-treated lecithin, sphingolipid, plant sterol, or trehalose. In utilization of proteinous materials, a method for blending oil and fats with albumen (JP-A-2-222669) and a method for blending a structural material containing polypeptide (JP-A-11-42054) have been studied. In the former method, however, the protein is not major functional material, and in the latter case the hydrolyzates of proteins are involved. At present, there is no technology in which nutritiously effective soybean proteins widely used as food materials are used as major ingredients.

On the other hand, there is a need for actively ingesting soybean proteins physiologically superb as nutrients in our dietary habits. In taking soybean proteins in our dietary habits, there are not many varieties of foods. It is difficult to eat always Japanese “Tofu” (soybean curd) or Japanese “Natto” (fermented soybeans). Though there is a product in the form of protein powder, it is desirous to take it in an ordinary form in order to enjoy our dietary habits. In addition, it has been attempted to prepare a soybean protein-containing food by adding soybean proteins to an ordinary food, particularly bakery products or baked confectioneries, and such products have already been commercialized. For example, the use of soybean germ as a nutritious food in cookies has been disclosed in JP-A-6-165656; a snack containing soybean flour or Japanese “Okara powder” (bean-curd residue powder) in JP-A-2-49538; cookies containing granular soybean proteins in JP-A-3-67536; and baked confectionaries, in which soybean proteins binding to an alkaline earth metal are blended, in JP-A-9-84511. In these protein enriched foods, however, soybean proteins cannot be taken sufficiently in many cases, and a need for a food, by which a large quantity of soybean proteins can be taken tastily, has not been satisfied. Particularly, in the field of baked type of wheat flour foods, there is no food in which soybean proteins are used as major ingredients or wheat flour is replaced totally with soybean proteins.

### DISCLOSURE OF INVENTION

As a result of an extensive investigation for dissolving the above-mentioned many problems, the present inventors have found that the problems can be solved by producing a baked food of wheat flour using a soybean protein in which NSI shows a low denature value of 40 or more, the content of solid component extracted with a solvent mixture of chloroform/methanol (2:1) is 2.0 wt % or less, and the crude protein content is 63% or more. Thus, the invention was completed. In this invention, the soybean protein may contain a component of Japanese “Okara” (soybean-curd residue). In such a case, the content of soybean protein is at most 78% as crude proteins because of the presence of Okara.

The invention provides a process for producing a baked food by preparing a dough from wheat flour and water, and baking the same, wherein a part or all of wheal flour is replaced with a soybean protein in which NSI shows a low denature value of 40 or more, the content of solid component extracted with a solvent mixture of chloroform/methanol (2:1) is 2.0 wt % or less, and the crude protein content is 63% or more.

The invention will be explained according to the embodiment of the respective major operations. First, the invention relates a process for producing a baked wheat flour product, which maintains the texture as just baked product even after freezing and subsequent thawing by heating with a microwave oven, by replacing 1-10 wt % of wheat flour with a soybean protein in which NSI shows a low denature value of 40 or more, the content of solid component extracted with a solvent mixture of chloroform/methanol (2:1) is 2.0 wt % or less, and the crude protein content is 63% or more, to prepare a dough, and baking and freezing the resulting dough to yield a baked wheat flour product (Invention of the first embodiment). The invention is effective for all of the baked wheal flour products distributed as frozen products, particularly effective for frozen foods such as pancakes, Japanese “Takoyaki” or Japanese “Okonomiyaki” (pancakes of unsweetened batter fried with various ingredients), which easily become stiff and sticky (strong influence) by heating in a microwave oven, though not limited to these products.

Further, the invention relates to a process for producing baked foods which comprises replacing most part or all (50 to 100%) of the starting wheat flour usually used in baked type foods with a soybean protein in which NSI shows a low denature value of 40 or more, the content of solid component extracted with a solvent mixture of chloroform/methanol (2:1) is 2.0 wt % or less, and the crude protein content is 63% or more, and then baking the resulting products (Invention of the second embodiment). According to this second embodiment, baked foods containing a soybean protein as major ingredient, which are resistant to freezing and have good physical properties and taste, can be produced. Thus, it becomes possible to take proteins in the form of great variety. The particularly preferred forms of the baked wheal flour foods include cookies, pound cakes, and Japanese “Okonomiyaki”.

In addition, the invention provides a process for producing a soybean protein in which NSI shows a low denature value of 40 or more, the content of solid component extracted with a solvent mixture of chloroform/methanol (2:1) is 2.0 wt % or less, and the crude protein content is 63% or more, which comprises treating low denatured defatted soybeans with an aqueous alcohol containing 60-85 vol % of alcohol, and then removing the alcohol and drying the product under high velocity of hot gas stream within a very short period of time. Thus, the product can be used in production of the baked foods of the first and second embodiments (Invention of the third embodiment). According to this process for producing a soybean protein, a low denatured soybean protein having a good color and taste can be obtained advantageously. The treatment with an aqueous alcohol in the invention may be carried out at a temperature of 35° C. or lower. The alcohol-removal and drying treatments is preferably carried out under hot air at a temperature of 200° C. or lower within a period of 5 minutes.

### BEST MODE FOR CARRYING OUT THE INVENTION

The followings will describe the preferred embodiment of the invention in more details.

The soybean proteins of the invention may be in any form of products as far as they can be processed into a form convenient for use in wheat flour products without causing denaturation of the proteins. However, since the high content of oil and fats is easily accompanied by deterioration of the taste, it is appropriate to use low denatured defatted soybeans treated with an organic solvent for defatting, of which the NSI (nitrogen solubilizing index) is 40 or more. In using in the invention, in order to enhance the quality (improvement of taste and color tone) and safety (reduction of viable count), the low denatured defatted soybeans which have been pre-treated with ethanol, the so-called alcohol concentrate, may preferably be used to suppress denaturation in the course of treatment and keep the NSI of 40 or higher.

In this invention, it is important that the proteins have never suffered from denaturation by heating. In particular, the following defatted soybeans are not suitable for use in this invention even if the NSI value is 40 or higher, since the proteins have been denatured once by heating in the case of those prepared by dispersing the protein materials such as defatted soybeans of NSI being 40 or lower into water to make NSI recover under pressured vapor, or those prepared by dispersing low denatured defatted soybeans into water followed by thermal sterilization and spray-drying while keeping the NSI value.

In the course of production of the soybean proteins, the presence of denaturation can be discriminated by differential scanning calorimetry (DSC) (Nagano et al., J. Agric. Food Chem., 40, 941-944 (1992)). According to this analytical method, in a case of undenatured soybean protein ingredients, there are observed endothermic peaks respectively originating in the major constituents 7S and 11S. However, when excessive denaturation occurs, no endothermic peak of the constituting proteins can be observed; thus, the presence of denaturation can easily be discriminated. Therefore, the low denatured soybean proteins used in the invention is preferably a protein wherein endothermic peaks of 7S and 11S can be observed definitely by DSC.

The particle size of the soybean proteins of the invention is desirable to be 50 mesh or smaller in view of homogeneous dispersibility in order to blend with wheat flour or dough, though the granulated powder may be larger than 50 mesh if it has been crushed once to smaller than 50 mesh.

It is not necessary to particularly define the residual oil component of soybean proteins since there is no direct relation with occurrence of the freezing-resistant function. But in view of deterioration of the taste due to the presence of oil component, it is desirable to keep the content of residual oil component in 1% or lower.

In order to obtain the objective low denatured soybean protein in the process for producing a soybean protein of the invention, it is appropriate to use low denatured defatted soybeans as raw materials. The low denatured defatted soybeans used in the invention are commercially available.

The color and taste of soybean proteins can be improved by treatment with an aqueous alcohol. The alcohol concentration has an influence on the efficacy of elimination of bad taste and coloring components and on denaturation of proteins. Excessively low alcohol concentration decreases the efficacy of elimination of fat-soluble components and increases the load to the product during drying, readily causing decrease of NSI. On the other hand, the excessively high concentration cannot eliminate sufficiently water-soluble components to be eliminated, though the decrease of NSI is suppressed. The preferred alcohol concentration is in the range of 60-85 vol % as an aqueous alcohol. The alcohol includes ethanol, ispropanol, and so on. The treatment with an aqueous alcohol may be carried out at a temperature of 35° C. or less, preferably 30° C. or less, and more preferably 25° C. or less, since NSI shows a tendency to decrease in a warm condition. In this operation, the fat-soluble components as indexes of bad taste and coloration, which are extracted with a solvent of chloroform/methanol (2:1), are reduced to 2.0% or less (calculated from the solid component). The proteins treated with an alcohol are readily denatured by drying. In order to suppress the denaturation as least as possible, it is essential to carry out the drying by the most thermally efficient drying method within a short period of time. This problem can be solved by enlarging the surface area of the product to be dried by crushing at drying, and exposing the crushed product to hot gas stream at high temperature instantaneously with fluidizing under atmosphere. The drying should be finished within 5 minutes, preferably within 2 minutes, more preferably within 1 minute. As an equipment and system satisfying this drying, it is appropriate to use a gas stream drying apparatus equipped with a crusher or a flash jet drying apparatus in which crushing and drying proceeds concurrently by collision under a high velocity of stream.

As to the heating temperature during drying, the drying time could be shorten if temperature is elevated, but excessively high temperature causes denaturation of soybean proteins irrespective of the time. The heating may be conducted at a temperature of 200° C. or less, preferably at 160° C. or less. When the heating is conducted at a lower temperature to suppress a thermal load, an excessive drop in temperature makes the shortening of time difficult. The heating is conducted preferably at a temperature 60° C. or more, accordingly.

The preferred embodiment of the invention will be illustrated in details by the following respective embodiment of operation referring to Examples.

### FIRST EMBODIMENT

### Baked Wheat Flour Foods Resistant to Freezing

As the amount of soybean protein to be added to foods in the embodiment of the invention, the soybean protein shows the function when wheat flour as a major component in a food is replaced in the range of 1 to 10 wt % with the soybean protein. Preferably, when 3-5% is replaced, an excellent function is generated. The soybean protein used in the invention can absorb much more water than wheat flour per se, and accordingly, it is possible to increase the amount of water to be added in comparison with the case of no replacement, that is, water may be added in an amount 2 to 3 times larger than the replaced soybean protein in preparation of dough. In such a case, the processing yield (weight and volume) of the product for the dough weight is equivalent to or higher than the dough containing no soybean protein even though the amount of water to be added is increased. Thus, improvement of the processing yield is expected. This effect is a part of the invention.

As to the occurrence of the function resistant to freezing, the reason is considered that the protein component suffering from no denaturation by heating mutually reacts with wheat proteins to inhibit agglutination of proteins during heating in a microwave oven. In addition, it is considered that when a moistening effect of bean-curd residue (Okara component) is added, softness is increased by a synergistic effect after heating in a microwave oven.

### EXAMPLES

The invention in the first embodiment will be explained in details by Examples and Comparative Examples, which are not intended to limit the invention.

### Production Example 1

Half-cut beans obtained from soybean seeds by removing the exodermis and hypocotyl were processed with a flaking roller (Yakushin Kogyo Co.) to yield rolling flakes of 0.2 mm in thickness. To 1 part by weight of the flakes was added 4-fold parts by volume of n-hexane, and the mixture was stirred with a propeller stirrer for 20 minutes to extract an oil component, which was separated from the solid portion by filtration under reduced pressure. This operation of the solid-liquid separation was repeated 3 times at a room temperature. The product was air-dried to yield 4.8 wt % of defatted soybeans (Sample 1) of which the crude protein content was 56.4%, NSI 89, residual oil (oil component extracted with ether) 0.5%, and a solid component extracted with a solvent mixture of chloroform and methanol (2:1) (hereinafter sometimes referred to as “chlo-metha extract”) 4.8 wt %.

### Example 1

Defatted soybeans (Sample 1) were treated with 75 vol % aqueous ethanol according to the method as described in JP-A No. 2000-325023. After replacement with a highly concentrated ethanol, the product was air-dried to remove the solvent, yielding a soybean protein (Sample 2) of which the crude protein content was 63.9%, NSI 68, and chlo-metha extract 1.1%.

### Example 2

To 1 part by weight of defatted soybeans (Sample 1) was added 6-fold parts by volume of 75 vol % aqueous ethanol, and the mixture was extracted with stirring with a propeller stirrer at 20° C. for 1 hour and then filtered under reduced pressure for solid-liquid separation. The separated pre-dried defatted soybeans were dried in a “Flash Jet Drier” (Type FJD-4B) (Seishin Kigyo Co.) at the heating temperature of 120° C. (temperature of heated air) and the exhaust gas temperature of 70° C. to remove the solvent, yielding a soybean protein (Sample 3) of which NSI was 65, and chlo-metha extract 1.4%.

### Example 3

Defatted soybeans were treated with an aqueous ethanol in the same manner as in Example 2, but the operation was conducted at 35° C. Thus, a soybean protein (Sample 4) of which NSI was 43 and chlo-metha extract 1.4% were obtained.

### Comparative Example 1

Defatted soybeans were treated with an aqueous ethanol in the same manner as in Example 2, but the operation was conducted at 60° C. Thus, a soybean protein (Sample 5) of which NSI was 10 and chlo-metha extract 0.7% were obtained.

### Comparative Example 2

The soybean protein of NSI=10 obtained in Comparative Example 1 was crushed, dispersed into 10-fold parts of water, and heated with steam at 120° C. under pressure for 15 seconds in a direct heating and sterilizing apparatus (Tanaka Shokuhin Kikai Co.) to recover NSI. The solution after treatment with steam under heating was pulverized by spray drying to yield a soybean protein (Sample 6) of NSI=81.

### Comparative Example 3

To the defatted soybeans (Sample 1) obtained in the Production Example was added 10-fold parts of water, and the mixture was adjusted at pH 7.5 with NaOH to extract proteins at room temperature of about 20° C. Solid portion was separated from the liquid portion by centrifugal separation to yield a defatted soybean milk. The defatted soybean milk was adjusted at pH 4.5 with HCl to recover precipitates, to which water was added so as to be about 10% solid content. The mixture was neutralized at pH 7.0 with NaOH, sterilized under heating, and spray-dried to yield separated soybean protein (Sample 7) of which the crude protein content was 90.5% and NSI 96.

### Comparative Example 4

Commercially available alcohol concentrate “Solpea 600” (Nissin Seiyu Co./NSI8) was used as Sample 8.

(Example of Application)

In order to homogeneously disperse, the soybean proteins as Samples 1 to 6 were crushed and sifted through a 120 mesh sieve to classify. In order to confirm the resistance to freezing, pancakes were made from the respective Samples prepared in Examples and Comparative Examples. After storage in a freezer, the pancakes were heated in a microwave oven to compare their texture.

[Pancake (Case 1)]

Using Sample 3 prepared in Example 2, the amount and effect of blend were confirmed. The amount of blend is indicated by part by weight.

TABLE 1
Blend

| (Component) | A | B | C | D | E | F | G | H | I |
|---|---|---|---|---|---|---|---|---|---|
| Soft flour | 100 | 99 | 97 | 97 | 95 | 90 | 90 | 80 | 75 |
| Milk | 100 | ← | ← | 97 | 95 | 90 | 100 | ← | ← |
| Raw egg | 25 | ← | ← | ← | ← | ← | ← | ← | ← |
| White sugar | 15 | ← | ← | ← | ← | ← | ← | ← | ← |
| Unsalted | 15 | ← | ← | ← | ← | ← | ← | ← | ← |
| butter | | | | | | | | | |
| Common salt | 1 | ← | ← | ← | ← | ← | ← | ← | ← |
| Water | — | — | — | 9 | 15 | 30 | — | — | ← |
| Sample 3 | — | 1 | 3 | ← | 5 | 10 | 10 | 20 | 25 |
| Baking | 3 | ← | ← | ← | ← | ← | ← | ← | ← |
| powder | | | | | | | | | |

Blend A indicates a control section; Blends B, C, G, H and I indicate the sections in which a certain amount of soft flour was replaced with Sample 3; Blends D, E and F indicate the experimental sections in which a certain amount of soft flour was replaced with Sample 3 and the amount of water added was increased.

(Step of Cooking)

A mixture of milk, raw egg, sugar, salt and water was placed in a Kenwood Mixer and agitated at a low speed for 15 seconds (2). Unsalted butter was dissolved by warming in hot water, added to (2), then stirred at a low speed for 60 seconds, then roughly agitated with a spatula, and further stirred at a low speed for 60 seconds (3). Dough (60 g) obtained in (3) was poured into a round mold of 85 mm in diameter, and baked both sides on a hot plate at 160° C. for 3 minutes. The baked product was allowed to cool, packaged, frozen at −40° C., and stored for 1 month.

(Result)

The frozen product was thawed in a microwave oven (650W/2-3 minutes), of which the texture was evaluated.

Section A: hard and sticky texture (strong influence)

Section B: good texture, hardness and stickiness improved

Section C: very soft and good texture

Section D: very soft and good texture

Section E: very soft and good texture

Section F: soft and good texture with no stickiness

Section G: soft texture with no stickiness

Section H: soft but adhesive texture

Section I: soft but adhesive texture

In Experimental Sections B to G, a good freezing-resistant function was observed, and the function was particularly appreciated in Sections C, D and E. Therefore, this indicated that the replacement of 1-10 wt % of wheat flour resulted in occurrence of the function, which was particularly high in the replacement of 3-5 wt %.

[Pancakes (Case 2)]

From the result of the addition experiment with Sample 3 of Example 2 obtained in Pancakes (Case 1), pancakes were made by replacement of 3% of wheat flour with Samples of the Production Example, Examples 1, 2 and 3, and Comparative Examples 1, 2, 3 and 4. The presence of resistance to freezing and the taste were evaluated. Heating in a microwave oven was carried out in the same condition as in Pancakes (Case 1).

(Blending)

The blend of Experimental Section A was employed as a control section. In Sections of the addition experiment, the amount of soft flour was reduced from 100 parts to 97 parts, and milk from 100 parts to 97 parts, respectively, to which 3 parts of Sample and 9 parts of water were added. The operation was made in the same manner as above.

(Result)

Control section: hard and sticky texture (strong influence) but taste good

Sample 1: very soft and good texture, but taste unfavorable

Sample 2: very soft and good texture, and taste good

Sample 3: very soft and good texture, and taste good

Sample 4: very soft and good texture, and taste good

Sample 5: soft but friable mouthfeel; taste good

Sample 6: somewhat soft, but sticky texture (strong influence); taste good

Sample 7: hard, sticky texture (strong influence); taste relatively good

Sample 8: soft but friable mouthfeel; taste good

Samples 1, 2, 3 and 4 gave just baked texture even after heating in a microwave oven; Samples 5, 6 and 8 showed soft but different texture from just after baking; Sample 7 had no improved effect. In the total evaluation involving the taste as foods, Samples 2, 3 and 4 were preferred.

[Example of Application 1: Pancakes (Case 3)]

Sample 3 of Example 2 and Sample 5 of Comparative Example 1 were blended into a commercially available pancake mixture “Morinaga's Hot Cake Mix” and cooked, frozen and thawed in a microwave oven. The texture of the respective products was compared.

| (Component) | Application A | Application B | Application C |
|---|---|---|---|
| Mixed flour | 100 parts | 97 parts | 97 parts |
| Sample 3 | — | 3 parts | — |
| Sample 6 | — | — | 3 parts |
| Milk | 75 parts | ← | ← |
| Raw egg | 25 parts | ← | ← |
| Water | — | 6 parts | 6 parts |

(Process)

Pre-sifted powder was admixed with each component at a low speed in a Kenwood mixer to yield a dough. The dough (60 g) was poured into a round mold of 85 mm in diameter, and baked both sides on a hot plate at 160° C. for 3 minutes. The baked product was allowed to cool at room temperature, packaged, frozen at −40° C., and stored for 1 month.

(Result)

The frozen product was thawed in a microwave oven in the same manner as in Pancakes (Case 1), and the texture was compared.

Application A: strongly sticky texture (strong influence)

Application B: soft and good texture

Application C: softer than A, but friable mouthfeel

Only in Application B, just baked texture was kept, and a high effect was also confirmed even in the product prepared by blending into a commercially available flour mixture.

[Example of Application 2: Japanese “Takoyaki”]

Grilled dumplings with bits of octopus (Japanese “Takoyaki”), in which a part of wheat flour was replaced with Sample 3 of Example 2, were made, and frozen/thawed in a microwave oven. The texture was compared with those made with wheat flour only.

| (Dough blended) | Application D | Application E |
|---|---|---|
| Soft flour | 100 parts | 95 parts |
| Sample 3 | — | 5 parts |
| Soup stock | 160 parts | 160 parts |
| Raw egg | 50 parts | 50 parts |
| Common salt | 2 parts | 2 parts |
| Water | — | 15 parts |

(Process)

Pre-sifted powder and dough components other than egg and salt are placed in a bowl and agitated gently with an eggbeater. The mixture is dispersed well, to which raw eggs are added with well stirring. Then, common salt is added thereto and agitated well to dissolve the salt, yielding dough. A baking pan for Takoyaki is heated, on which pieces of octopus sliced in 1 cm cube are placed in each well and baked for 10 to 20 seconds and then the dough is poured. When the periphery of the dough is solidified, the dumplings are turn over with an eyeleteer and baked (baking time: about 7 minutes). The baked product was allowed to cool at room temperature, packaged, frozen at −20° C., and stored for 1 month.

(Result)

The frozen product was thawed in a microwave oven and the texture was compared (the condition in the oven: 650W/2-3 minutes for 3 dumplings of Takoyaki).

Application D Harder and poorer in juicy texture than just after baking

Application E Rich in soft and juicy texture equivalent to the product just after baking

### SECOND EMBODIMENT

### Baked Wheat Flour Foods Containing a Soybean Protein as Major Component

As in the first embodiment, soybean protein in this embodiment includes a low denatured one in which the NSI is 40 or higher and the solid component extracted with a solvent mixture of chloroform and methanol (2:1) is 2.0 wt % or lower, and the crude protein content 63 wt % or higher. Even if soybean protein products other than those of the invention, for example, ordinarily separated soybean proteins or commercially available enriched soybean proteins or materials as defatted soybeans, are used in replacement of most or all of wheat flour, it is not possible to obtain the objective wheat flour foods of baked type.

For example, ordinarily separated soybean proteins have a high water retention power, which increases the viscosity of dough and greatly decrease workability. In the baked products such as cookies or pound cakes, moisture is removed incompletely by baking; the resulting cookies are not in a crunchy state; pound cakes give incompletely burn heavy texture; Japanese “Okonomiyaki” (pancakes of unsweetened batter fried with various ingredients) gives dumpling-like heavy texture; when these are frozen and preserved, the texture turns hard with a lapse of time by freezing denaturation to decrease the taste.

At the time of filing of this application, there was no commercially available product of enriched soybean protein of which NSI was 40 or higher. The enriched soybean proteins of which NSI is less than 40 are poor in form-maintaining capacity, and the resulting baked product is powdery and has unpleasant taste. Since the enriched soybean proteins of which NSI is 40 or higher are processed with steam to elevate NSI, the proteins are once thermally denatured and have the same disadvantage as the separated soybean proteins. When soybean flour or defatted soybeans are used, the taste becomes extremely worse. When soybeans powder completely lacking lipoxygenase or defatted soybeans are used, there is a problem that the taste is better than the former but it generate a peculiar strong bitter taste possibly derived from glycosides. Granulated soybean proteins (histoid soybean proteins) have been used sometimes as auxiliary agents for strengthening additives and proteins, but they are almost insoluble in water for use in totally replacing wheat flour. Therefore, they have no form-maintaining capacity and cannot be made into cookies or Okonomiyaki; pound cakes give incompletely burn heavy texture, in which oil and fats are not emulsified to give an oily taste and bad color tone. Thus, it is not possible to obtain any desired food. Anyhow, using soybean proteins as major components (50-100%), it is difficult to obtain normal type of foods which have an ordinary taste and texture and can be taken in the same sense as the usual wheat flour foods of baked type.

High blend adaptability of the soybean proteins of the invention to baking-processed foods is considered to depend on the following reasons: (1) the protein has NSI of 40 or higher but does not suffer from vast denaturation, and when dispersed in water the viscosity of its solution is lower than that of other soybean proteins, assuring good workability; (2) the baked form of dough of the soybean protein is maintained by the dissolved protein and components of Japanese “Okara” (bean-curd residue); (3) a sugar portion has been removed so that the content of a polar lipid component as an indicator of taste and major solid component, which is extracted with a solvent mixture of chloroform and methanol (2:1), is 2.0 wt % or less, and the content of crude proteins is 63% or more; (4) in the baked dough the degree of freezing denaturation is very small since the soybean protein is only once effected by thermal denaturation and the ingredient of Okara co-exists.

### EXAMPLES

The embodiment on cookies, pound cakes and Okonomiyaki made in the invention will be explained respectively by the following examples which are not intended to limit the art of cooking and the amount of blend.

### Production Example 2

### Production of Soybean Protein

To low denatured defatted soybeans was added 7-fold parts of 65 vol % aqueous ethanol, and the mixture was stirred with a propeller at 20° C. for 1 hour for washing. The solid portion was separated from the liquid portion by filtration under reduced pressure, and the defatted pre-dried soybeans were thrown in hot air at the inlet temperature of 122° C. using a “Flash Jet Drier” (Type FJD-4B) (Seishin Kigyo Co.), during which operation the beans were fed so that the exhaust gas temperature could be kept at 65° C. After removal of the solvent and drying, the beans were sifted through a 120 mesh sieve for classification to give a soybean protein (enriched soybean protein). The NSI value of this product was 65, the amount of crude proteins was 64.5%, and the solid portion extracted with a chloroform/methanol mixture was 1.5%.

### Example 4

### Cookies

Margarine (100 parts by weight) and white sugar (84 parts by weight) were stirred in a mixer, during which operation egg yolk (16 parts by weight) and water (40 parts by weight) were slowly added. When the specific gravity reached approximately 0.9, the enriched soybean protein (120 parts by weight) obtained in the production Example was added and stirred lightly to yield a dough. This was formed into cookies of 55 mm in diameter and 4 mm in thickness, which were baked on an oven at 160° C. for 15 minutes.

### Comparative Example 5

The enriched soybean protein obtained in the Production Example 2 was referred to as A; commercially available soybean protein for comparison, that is, separated soybean protein “New Fujipro SE” (Fuji Oil Co., Ltd.), referred to as B; enriched soybean protein “Solpea 600” (Nisshin Oil Mills) referred to as C; and “Promin HV” (Central Soya Co. Ltd.) referred to as D. Using them, cookies were made in the same manner as in Example 4 and compared with those made with commercially available soybean protein.

The commercially available soybean protein used as comparative sample will be supplementally explained as follows. In “New Fujipro SE”, NSI is 92, the crude protein content is 91%, and chlo-metha extract is 4.5%. In “Promin HV”, NSI is 67, the crude protein content is 66%, and the solid portion extracted with a solvent mixture of chloroform and methanol is 1.7%. In “Solpea 600”, NSI is 8, the crude protein content is 67%, and chlo-metha extract is 1.2%.

TABLE 2
Result of Comparison 1

Sort of Protein

| | A | B | C | D |
|---|---|---|---|---|
| Workability | ⊚ | Δ | X | Δ |
| Form-maintaining | ◯ | ⊚ | X | ⊚ |
| capacity of dough | | | | |
| Form-maintaining | ◯ | ⊚ | Δ | ◯ |
| capacity after baking | | | | |
| Texture after baking | ⊚ | X | X | Δ |
| Taste after baking | ⊚ | X | ◯ | Δ |
| General evaluation | 1st | 3rd | 4th | 2^{nd} |
| (Order) | | | | |

In Table 2, the double circle ⊚ indicates ‘very good’, the single circle ◯ indicates ‘good’, the triangle Δ indicates ‘slightly good’, and the cross mark × indicates ‘worse’ Specifically, the workability indicates the degree of hardness of dough; the form-maintaining capacity of dough is regarded as good when the shape can easily be made; the form-maintaining capacity after baking is regarded as good when few are broken; Texture after baking is regarded as good when crunchy and smooth mouthfeel are recognized; and Taste after baking is regarded as good when it is accepted pleasantly.

As seen from the above results, when the enriched soybean proteins were employed, the workability, form-maintaining capacity of dough and form-maintaining capacity after baking were judged as good; particularly, in the taste and texture after baking, well-baked and crunchy mouthfeel was recognized with the taste faintly showing soybean, indicating the cookies being highly appreciated. Though the protein content in ordinary cookies is about 5% when soft flour is used, when the enriched soybean protein is used, the content reaches about 23%, that is, protein-enriched cookies can be obtained.

### Example 5

### Pound Cakes

Margarine (200 parts by weight) pre-softened at room temperature and white sugar (200 parts by weight) were stirred in a mixer at a low speed. When the mixture became smooth, there was added scrambled raw egg (200 parts by weight) in small portions. When the specific gravity reached approximately 0.85, the stirring was ceased, and the enriched soybean protein (100 parts by weight) produced in the Production Example was added. The mixture was slightly mixed using a rubber spatula to yield a dough. Thus prepared dough (300 ml) was poured into a pound mold of 80 mm×120 mm, and baked in an oven at 160° C. for 40 minutes to yield pound cakes.

### Comparative Example 6

Using the soybean proteins A, B, C and D as shown in Comparative Example 5, pound cakes were made in the same manner as in Example 5, and the difference depending on the soybean proteins was compared and evaluated.

TABLE 3
Result of Comparison 2

Sort of Protein

| | A | B | C | D |
|---|---|---|---|---|
| Workability | ◯ | Δ | ◯ | Δ |
| State of dough | ⊚ | Δ | ◯ | Δ |
| Color tone after | ⊚ | ◯ | Δ | X |
| baking | | | | |
| Texture after baking | ⊚ | Δ | X | Δ |
| Taste after baking | ⊚ | X | X | ◯ |
| General evaluation | 1st | 2nd | 4th | 3^{rd} |
| (Order) | | | | |

The significance of each symbol in Table 3 is the same as in Table 2. The workability indicates the degree of difficulty in making the dough; the state of dough indicates the smoothness of the dough surface when poured into a pound mold; the color tone after baking indicates the quality of the color tone on the baked surface and in the inside; the texture after baking is regarded as good when loosening in the mouth is pleasant; and the taste after baking is regarded as good when it is accepted pleasantly.

As seen from the above results, when the enriched soybean protein produced in the Production Example 2 was employed, the workability was good because a smooth surface was formed when poured into a mold as the dough viscosity was low. As to the color tone after baking, the baked surface and inside both were finished finely. The texture after baking was good because properly loosened, and the taste after baking was good, too. Thus, much better pound cakes were obtained.

Though the protein content in ordinary pound cakes is about 4% when soft flour is used, when the enriched soybean protein produced in the Production Example 2is used, the content reaches about 12%, that is, protein-enriched pound cakes can be obtained.

### Example 6

### Japanese “Okonomiyaki”

Enriched soybean protein (100 parts by weight) produced in the Production Example 2, water (150 parts by weight) ,baking powder (3 parts by weight), dry yam (6 parts by weight), common salt (1 part by weight), instant bouillon (2.5 parts by weight), raw egg (75 parts by weight), and roughly cut cabbage (260 parts by weight) were provided. The egg was scrambled. These materials other than cabbage were placed in a mixer and mixed at a low speed to be homogeneous. At this stage, cabbage was admixed and lightly agitated to yield a dough. This dough (120 g) was poured into a mold frame of 110 mm in diameter placed on a hot plate, and the both sides were baked at 170° C. respectively for 6 minutes. The baked Okonomiyaki was allowed to cool to room temperature, enveloped with a lapping film, frozen in a shock freezer, and preserved in a home freezer at −10° C. The frozen Okonomiyaki after a lapse of 30 days was thawed in a 1 kw microwave oven for 3 minutes, and the change during freezing was also evaluated.

### Comparative Example 7

Using the soybean proteins A, B, C and D as shown in Comparative Example 5, Okonomiyaki was made in the same manner as in Example 6, and the difference depending on the soybean protein was compared and evaluated.

TABLE 4
Result of Comparison 3

Sort of Protein

| | A | B | C | D |
|---|---|---|---|---|
| Workability | ◯ | ◯ | ◯ | ◯ |
| Fluidity of dough | ⊚ | Δ | ◯ | Δ |
| Form-maintaining | ◯ | ⊚ | X | Δ |
| capability after | | | | |
| baking | | | | |
| Taste after baking | ⊚ | X | Δ | ◯ |
| Texture after baking | ⊚ | ◯ | X | Δ |
| Texture after | ⊚ | Δ | X | X |
| thawing | | | | |
| General evaluation | 1st | 2nd | 4th | 3^{rd} |
| (Order) | | | | |

The significance of each symbol in Table 4 is the same as in Table 2. The workability indicates the degree of difficulty in making the dough; the fluidity of dough is regarded as good when the viscosity is low; the form-maintaining capability after baking is regarded as good when no deformation is observed during baking; the taste after baking is regarded as good when it is accepted pleasantly; the texture after baking is regarded as good when well-baking and crispy mouthfeel is recognized; and the texture after thawing is regarded as good when no great change with a lapse of time is observed.

As seen from the above results, when the enriched soybean protein produced in the Production Example 2 was employed, the workability and the form-maintaining capability after baking were good because the dough viscosity was low. The baked product has the taste faintly showing soybean and holds crispy mouthfeel. After freezing and thawing, just baked texture is maintained, and good Okonomiyaki-like food can be obtained, though an image is slightly different from the Okonomiyaki made with original wheat flour. Though the protein content in ordinary Okonomiyaki is about 3.5% when soft flour is used, when the enriched soybean protein produced in the Production Example 2 is used, the content reaches about 14%, that is, protein-enriched Okonomiyaki can be obtained.

### THIRD EMBODIMENT

### Production of Soybean Protein

The followings will illustrate the third embodiment of the invention.

The concept of alcohol treatment is as mentioned above. In order to increase the efficiency of drying after the alcohol treatment, it is appropriate to separate the solid portion from the liquid portion before drying. The solid-liquid separation may be achieved by a conventional way such as centrifugal filtration, filtration under reduced pressure, or filter press.

In drying, it is important to carry out it within a short period of time to suppress decrease of NSI. In this invention, a jet stream drying method (flash jet drying apparatus) has been proposed, though the other methods such as vacuum drying which is carried out under reduced pressure at a low temperature or fluid-bed drying conducted under gas stream may be taken into consideration. The present inventors examined on these drying apparatus, but it was difficult to achieve drying within a period as short as 5 minutes in these systems, resulting in decrease of NSI in the produced soybean proteins. In vacuum drying, the dried product is accompanied by blocking by aggregation due to a considerable amount of water and adhesion on the wall of vessel, resulting in unfavorable uneven drying. In fluid-bed drying, adhesion on the wall of vessel occurs too, and the drying time is prolonged more than in the jet stream drying since there is no crushing effect; as a result, unfavorable denaturation and deterioration of color tone are generated.

In the alcohol-treated defatted soybeans (i.e., alcohol concentrate) obtained by short-time drying such as jet stream drying, lower denaturation and higher NSI (nitrogen solubilizing index; a standard of denaturation of proteins) are recognized. Damage is scarcely recognized but decrease of NSI inherent to the processing with an aqueous alcohol.

The soybean protein prepared in the above treatment have high NSI and good taste and color tone. Therefore, it is possible to make defatted soybean milk and separated soybean proteins with the raw protein materials of the invention. The protein products and soybean whey produced from the soybean proteins of the invention have much better taste and color tone.

### EXAMPLES

The invention will be explained in details by the following examples, which are not intended to limit the spirit of the invention.

### Example 7

To 40 kg of defatted soybeans (NSI=85) was added 6-fold parts of 75 vol % aqueous ethanol (240 L of aqueous ethanol for 40 kg of defatted soybeans), and the mixture was stirred at room temperature of about 20° C. with a propeller for 1 hour for washing. The solid portion was separated from the liquid portion by filtration under reduced pressure. The content of liquid in the pre-dried defatted soybeans after separation was 59.3wt %. The defatted soybeans washed with ethanol were dried in a “Flash Jet Drier” (Type FJD-4B) (Seishin Kigyo Co.) to yield 34.3 kg of soybean protein.

### Comparative Example 8

To 10 kg of defatted soybeans (NSI=85) was added 45 L of 75 vol % aqueous ethanol, and the mixture was stirred with a propeller for 1 hour for washing. Solid-liquid separation was carried out by filtration under reduced pressure to yield 17.5 kg of alcohol-treated defatted soybeans in a pre-dry state containing 55.4 wt % of liquid. The resulting alcohol-treated defatted soybeans were washed with 15 L of 99.5% ethanol 3 times for 15 minutes (solid-liquid separation was carried out by filtration under reduced pressure). The liquid content was adjusted to 54.2 wt % by final filtration under reduced pressure, and the filtrate was spread thinly and dried in atmosphere at room temperature of about 20° C. without heating.

### Comparative Example 9

To 10 kg of defatted soybeans (NSI=85) was added 60 L of 75 vol % aqueous ethanol, and the mixture was stirred with a propeller for 1 hour for washing. Solid-liquid separation was carried out by filtration under reduced pressure to yield the filtrate containing 55.4 wt % of liquid, which was spread thinly and dried in atmosphere at room temperature of about 20° C. without heating.

The results in Example 7 and Comparative Examples 8 and 9 are shown in Table 5.

TABLE 5

| | Example 7 | Com. Ex. 8 | Com. Ex. 9 |
|---|---|---|---|
| Drying time (hr) | — | 21 | 49 |
| Heating Temp. (° C.) | 122 | 20 | 20 |
| Product moisture (%) | 4.0 | 9.0 | 14.7 |
| NSI after drying | 70 | 71 | 31 |

In Example 7 as shown in Table 5, drying was carried out in a moment (a few seconds) by jet stream drying using with 9 m³/minute of stream through a tube of 4 inch in size. In Comparative Examples 8 and 9, the time required for no ethanol smell recognized is shown. NSI of Comparative Example 8 indicates decrease inherent to alcohol treatment. NSI of Comparative Example 9 indicates the damage caused by ethanol containing much water during drying. NSI of Example 7, however, is approximately equal to that of Comparative Example 8, indicating that almost no damage occurs during drying.

### Example 8

To defatted soybeans (NSI=85) was added 6-fold parts of 75 vol % aqueous ethanol, and the mixture was stirred with a propeller for 1 hour for washing. The washing temperature was fixed at 15° C., 25° C. or 35° C. After solid-liquid separation, a test by FJD-4B was carried out. NSI after drying was 71 at 15° C., 66 at 25° C., and 45 at 35° C. Decrease of NSI in this case is caused by the temperature during alcohol treatment.

### Example 9

The liquid content of pre-dry defatted soybeans produced in the same manner as in Example 7 was 55.1 wt %. The ethanol washed defatted soybeans were dried in a “Dry Master (Type DMR-1: a gas stream drying apparatus equipped with a crusher)” (Hosokawa Micron Co.) to yield soybean protein.

Table 6 shows the results of Example 9.

TABLE 6

| | Experiment 1 | Experiment 2 |
|---|---|---|
| Volume of gas stream (m³/min) | 9 | 9 |
| Amount treated (kg/min) | 0.52 | 0.64 |
| Drying Temperature (° C.) | 100 | 120 |
| Moisture in final product (%) | 4.8 | 4.4 |
| NSI of the product | 68.0 | 66.5 |

The drying in Example 9 was accomplished within a period of 1 minute.

The crushing mechanism of “Flash Jet Drier” in Example 7 is based on a jet mill system by a high velocity of gas stream, and that of “Dry Master” depends on an impact crushing system. However, it was found from Tables 5 and 6 that there was no considerable difference between the NSI values of the products depending on the difference of the crushing process.

### Example 10

Pre-dry defatted soybeans were produced in the same manner in Example 7. The soybeans were dried in the respective conditions under heating at 120° C., 160° C. and 200° C. using FJD-4B. The NSI values were 70 at 120° C., 61 at 160° C. and 49 at 200° C., respectively.

### Comparative Example 10

To defatted soybeans (NSI=85) was added 6-fold parts of 75 vol % aqueous ethanol, and the mixture was stirred for 1 hour for washing. The liquid content of the defatted soybeans after solid-liquid separation was 57.6%. The resulting ethanol treated pre-dry defatted soybeans were dried in a fluid-bed drier (FBS-0.5M) (Ohkawara Seisakusyo Co.).

### Comparative Example 11

Using a part of the pre-dry defatted soybeans prepared in Comparative Example 10, a drying test was carried out under reduced pressure at −50 mmHg in a 10 L rotary evaporator.

Table 7 shows the results of Comparative Examples 10 and 11.

TABLE 7

| | Com. Ex. 10 | Com. Ex. 11 |
|---|---|---|
| Drying Method | (fluid bed) | (in vacuo) |
| Drying Time (min) | 25 | 120 |
| Drying Temperature (° C.) | 90 | 70 |
| Moisture in final product (%) | 5.5 | 6.5 |
| NSI after drying | 24 | 58 |

As seen from Table 7, NSI decreases in any cases because of damage by drying. In drying under reduced pressure, a considerable amount adheres on the wall of vessel (flask) during drying; as a result only 80% could be recovered as the product for the theoretical yield.

### Example 11

The enriched soybean proteins produced in Example 7 was sifted through a 120 mesh sieve for classification to yield the product in 95% yield. Then, the denatured defatted soybeans as a raw material were crushed to yield a 120-mesh sifted product. Both were admixed respectively with 3-fold parts of water to prepare pastes. The color tone was measured by a chromaticity meter (Nippon Densyoku Co.). In addition, a 5% aqueous suspension of the product was prepared to evaluate the taste functionally. There was a clear difference between them, indicating that the soybean proteins produced in Example 7 were much better.

TABLE 8
shows the difference of color tone.

| Color Tone of | Alcohol-treated | Non-denatured |
|---|---|---|
| Paste | product | Defatted soybeans |
| L value | 64.5 | 48.1 |
| a value | 0.0 | 3.2 |
| b value | 16.5 | 18.6 |
| Hunter whiteness | 60.9 | 44.8 |

There is a great difference in the color tone as seen from Table 8, indicating that the color tone is markedly better in the alcohol-treated defatted soybean paste.

### Example 12

To 5 kg of soybean proteins produced in Example 7 was added 50 L of hot water at 50° C., and the mixture was adjusted at pH 7.2, stirred for 1 hour, and centrifuged (3000 G) for solid-liquid separation to remove Okara. The resulting defatted soybean milk was adjusted at pH 4.5, and the precipitate was recovered by centrifugation, to which was added water. The mixture was neutralized to pH 7.0, sterilized under heating, and spray-dried to yield separated proteins (SPI), of which a 5% aqueous solution had no muddiness with rather clear appearance and the color tone and taste were much better.

### INDUSTRIAL APPLICABILITY

According to the invention, widely applicable soybean proteins having good taste can be produced. Addition of these proteins to baked foods of wheat flour allows production of foods resistant to freezing, which are preferred in stock. In addition, when the soybean proteins are added to wheat flour foods of baked type in place of wheat flour, foods which allow the intake of a large amount of soybean proteins can be produced. Such foods in our dietary habits allows expansion of a variety of intake ways for nutritionally and physiologically effective soybean proteins.

1. A process for producing a baked food by preparing a dough from wheat flour and water and baking the resulting dough, wherein a part or all of wheal flour is replaced with a soybean protein in which NSI shows a low denature value of 40 or more, the content of solid component extracted with a solvent mixture of chloroform/methanol (2:1) is 2.0 wt % or less, and the crude protein content is 63% or more.

2. A process as claimed in claim 1, wherein the rate of replacement of wheat flour with a soybean protein is 1 to 10 wt %, and the baked product is frozen.

3. A baked food as described in claim 1, wherein the rate of replacement of wheat flour is 50 to 100%.

4. A baked food as claimed in claim 3 which is a cookie-like, pound cake-like or Okonomiyaki-like food.

5. A process as claimed in claim 1, wherein the soybean protein contains Okara in addition to soybean protein.

6. A process as claimed in claim 1, wherein the soybean protein is produced by washing and processing low denatured defatted soybeans with an aqueous alcohol.

7. A process as claimed in claim 6, wherein the soybean protein is produced by treating the low denatured defatted soybeans with an aqueous alcohol solution in which the alcohol content is 60-85 vol %, followed by alcohol-removal/drying at a high velocity of a hot gas stream in a moment.

8. A process as claimed in claim 6, wherein the treatment with an aqueous alcohol solution is carried out at 35° C. or lower.

9. A process as claimed in claim 7, wherein the alcohol-removal/drying is carried out at a temperature of 200° C. or lower within a period of 5 minutes.

10. A process for producing a soybean protein in which NSI shows a low denature value of 40 or more, the content of solid component extracted with a mixture of chloroform/methanol (2:1) is 2.0 wt % or less, and the crude protein content is 63% or more, which comprises treating low denatured defatted soybeans with an aqueous alcohol solution in which the alcohol content is 60-85 vol %, followed by alcohol-removal/drying at a high velocity of a hot gas stream within a short period of time.

11. A process as claimed in claim 10, wherein the treatment with an aqueous alcohol solution is carried out at 35° C. or lower.

12. A process as claimed in claim 10, wherein the alcohol -removal/drying is carried out at a temperature of 200° C. or lower within a period of 5 minutes.
